(19) United States
(12) Patent Application Publication
(10) Pub. No.: US 2013/0346437 A1
(43) Pub. Date: Dec. 26, 2013

(54) PROJECT-BASED DIRECTORY

(71) Applicant: Stefano Sanchini, New York, NY (US)

(72) Inventor: Stefano Sanchini, New York, NY (US)

(21) Appl. No.: 13/914,750

(22) Filed: Jun. 11, 2013

Related U.S. Application Data
(60) Provisional application No. 61/658,137, filed on Jun. 11, 2012.

(51) Int. Cl. G06F 17/30

(52) U.S. Cl. CPC G06F 17/30424
USPC 707/769

(57) ABSTRACT

A project-based database system includes client profiles and project profiles. Each project profile is associated with at least one client profile and each of the client profiles is associated with at least one project profile. The client profiles and the project profiles are stored in a database configured to support a search query and return data corresponding to the search query.

### CROSS-REFERENCE TO RELATED APPLICATIONS

This application claims the benefit of Provisional Application Ser. No. 61/658,137, filed on Jun. 11, 2012, the disclosure of which is incorporated by reference herein in its entirety.

### BACKGROUND

1. Technical Field

The present invention relates to information retrieval, and more particularly to a project-based directory.

2. Description of Related Art

Project management is the discipline of planning, organizing, securing, managing, leading, and controlling resources to achieve specific goals. A project is a temporary endeavor with a beginning and end, undertaken to meet unique goals and objectives. The temporary nature of projects stands in contrast with ongoing business operations, which are repetitive, permanent, or semi-permanent functional activities to produce products or services. In practice, the management of these two systems is often quite different, and as such requires the development of distinct technical skills and management strategies.

One challenge of project management is to achieve all of the project goals and objectives while honoring the preconceived constraints. Typical constraints are scope, time, and budget. Another challenge is to optimize the allocation of necessary inputs and integrate them to meet pre-defined objectives.

### SUMMARY OF THE INVENTION

According to an exemplary embodiment, a project-based database system includes client profiles and project profiles. Each project profile is associated with at least one client profile and each of the client profiles is associated with at least one project profile. The client profiles and the project profiles are stored in a database configured to support a search query and return data corresponding to the search query.

In an exemplary embodiment, the project-based database includes a spaces database including a retail area, a residential area, a commercial area, and a real estate area, wherein the plurality of client profiles is stored in the spaces database, and the plurality of client profiles is divided among the retail area, the residential area, the commercial area, and the real estate area based on a client indicator, an information database, wherein the plurality of project profiles is stored in the information database, and an advertisement and communication facilities database including advertisement data corresponding to at least one client profile.

In an exemplary embodiment, each client profile includes data corresponding to a vendor providing products or services, and each project profile comprises data corresponding to a construction project.

In an exemplary embodiment, the search query is based on a vendor category. The vendor category may include an architect, a designer, an engineer, a contractor, or a supplier.

In an exemplary embodiment, the search query is based on a key word representing a product or a service designated in at least one of the plurality of client profiles.

According to an exemplary embodiment, a method of managing a project-based database system includes generating a plurality of client profiles, generating a plurality of project profiles, and storing the plurality of client profiles and the plurality of project profiles in a database configured to support a search query and return data corresponding to the search query. Each project profile may be associated with at least one client profile and each of the client profiles may be associated with at least one project profile.

In an exemplary embodiment, each project profile is further associated with a plurality of parameters including a location, an address, and a project description.

In an exemplary embodiment, the method further includes storing the plurality of client profiles in a spaces database including a retail area, a residential area, a commercial area, and a real estate area, wherein the plurality of client profiles is divided among the retail area, the residential area, the commercial area, and the real estate area based on a client indicator, and storing the plurality of project profiles in an information database.

In an exemplary embodiment, each client profile includes data corresponding to a vendor providing products or services, and each project profile includes data corresponding to a construction project.

In an exemplary embodiment, the method includes receiving the search query, wherein the search query is based on a location, a specific project, a vendor name, or a vendor category. The vendor category may include an architect, a designer, an engineer, a contractor, or a supplier.

In an exemplary embodiment, the method includes receiving the search query, wherein the search query is based on a key word representing a product or service designated in at least one of the plurality of client profiles.

In an exemplary embodiment, the method includes generating an advertisement corresponding to at least one client profile based on the key word.

### BRIEF DESCRIPTIONS OF THE DRAWINGS

Preferred embodiments of the present disclosure will be described below in more detail, with reference to the accompanying drawings:

FIG. 1 is a diagram of an exemplary directory, according to an embodiment of the present disclosure;

FIG. 2 is a diagram illustrating exemplary applications of the spaces directory of FIG. 1;

FIG. 3 is a diagram illustrating different areas within the spaces directory and a correlation with profiles and a server, according to embodiments of the present disclosure;

FIG. 4 is a diagram of an exemplary profile structure according to embodiments of the present disclosure;

FIGS. 5-7 are respective exemplary diagrams of exemplary profiles according to embodiments of the present disclosure;

FIG. 8 is a diagram showing a database structure according to an embodiment of the present disclosure;

FIG. 9 illustrates search results according to an embodiment of the present disclosure;

FIGS. 10-11 are diagrams showing respective database structures according to embodiments of the present disclosure;

FIGS. 12-15 illustrate an example of different screens of a user interface providing access to the project-based directory, according to embodiments of the present disclosure;

FIG. 16 is a flowchart showing a method of managing a project-based database system, according to embodiments of the present disclosure; and

FIG. 17 shows an exemplary computer system for executing a method according to an embodiment of the present disclosure.

### DETAILED DESCRIPTION OF PREFERRED EMBODIMENTS

According to an embodiment of the present disclosure, a project-based database may support efficiencies of scale in unique environments by connecting clients having prior knowledge. As used herein, a client may refer to a person or a company providing products or services, and a project may refer to a construction project. For example, a project-based database may be searchable such that a client who wishes to develop a retail space may mine the project-based database. The project-based database may be mined for various information, including the identity of clients who performed work having similar characteristics, the work at a particular site, etc.

Each client of the system may create their own profile. The profile may be filled with professional information about projects (e.g., previous and current projects) and information about the client (e.g., company contact information, professional memberships, capabilities, etc.). The information of the profile will automatically link to other client's information. The linked profiles form the project-based database.

Consider the following example; an Architect working on a retail development on 5^{th} Avenue in New York may input the project into his profile. An Engineer working on the project will do the same, like all the clients (e.g., vendors and suppliers) involved in the project. The clients may include, for example, lighting consultant, millworker and the like. Given a resultant database, a query on the database for the retail development in New York may return a list of information about each client involved in the project.

According to an embodiment of the present disclosure, each client may input key words into their profile describing the services provided (e.g. wood floor supplier). Accordingly, the database may be queried for specific classes of products or services. The database may deliver a list of vendors that perform and deliver a specific product in a specific location (e.g., New York, Chicago, etc.).

According to an embodiment of the present disclosure, advertisements of select clients may be displayed. For example, an advertisement may be displayed with a list of information returned for a given query. The advertisement may be purchased by the client. For example, when searching for “wood floors,” advertisements of selected suppliers may be displayed with the list of venders, Architects, etc. that work with “wood floors.”

In view of the foregoing, an exemplary project-based database includes information for specific projects at certain locations such that new projects at the same or similar location or having the same or similar characteristics may be mined for information. Mined information from the project-based database may include the identity of different vendors, e.g., architect, engineer, general contractor, the project owner (e.g., the previous tenant in the location), information regarding governmental regulations and permits, etc. Accordingly, mined information may be collected and adapted to a new project, which may create efficiencies aiding the new project to achieve goals and objectives.

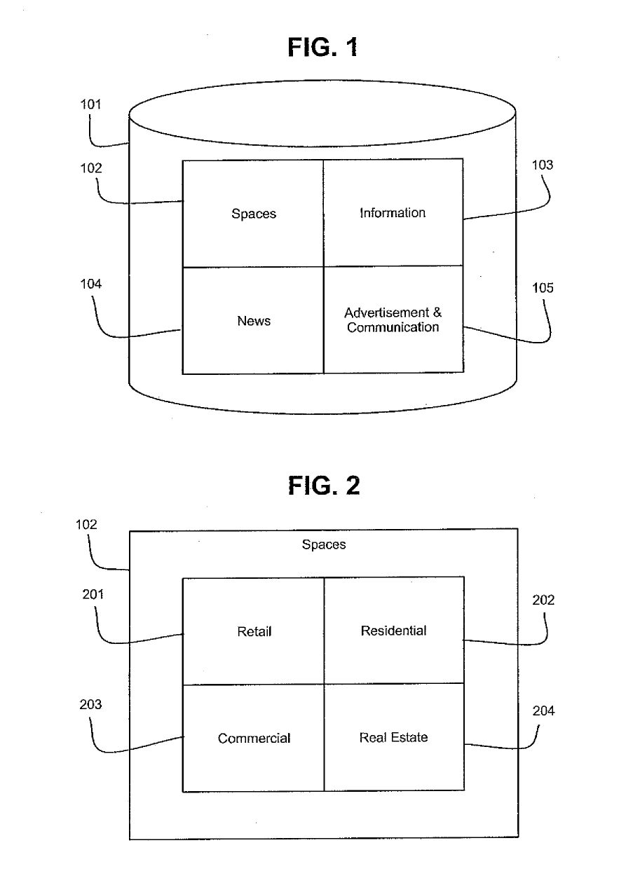

As show in FIG. 1, an exemplary directory 101 comprises a plurality of databases. For example, the directory may includes a spaces database for a plurality of clients 102, an information database containing data about projects performed by the plurality of clients 103, a news database including information about the projects and clients 104, and an advertisement and communication facilities database 105. The advertisement and communication facilities database 105 includes advertisement data corresponding to at least one client profile. The utilization of advertisements in the project-based directory system is described in further detail below.

The information that each client provides may be stored in different areas. Each area contains specific data collected from each client's profiles (e.g., contacts and information). The information each client inputs into their profile will be stored by a database system in the database. The database may include different areas. As shown in FIG. 2, a spaces database 102 includes retail 201, residential 202, commercial 203 and real estate 204 areas or components. Each client profile may be stored in the appropriate area in the spaces database based on a client indicator which indicates the type of client each client profile belongs to (e.g., each client profile may include a retail indicator, a residential indicator, a commercial indicator, or a real estate indicator). That is, the client profiles may be divided among the retail 201, the residential 202, the commercial 203, and real estate areas 204 based on the client indicators. Each client (e.g., person or company) may start a search selecting an area of interest (e.g. the retail area). The search can then be made by location (e.g., Los Angeles), by specific projects (e.g., Gucci New York), by Category (e.g., architects) or by a specific vendor's name (e.g., Erco Lighting).

Consider the following example; a client may choose to search within the to residential database 202. Within the residential database 202, the client may switch between searching from an Architect, to a Designer, to a specific material, to recent projects (e.g., the remodeling of apartments), etc. For example, the client may search for specific projects or installations such as, for example, “roof gardens”, and the project-based directory will display a list of past, current, and future projects related to “roof gardens” in various locations to the client. Each project presented to the client will include information such as, for example, who designed the projects, details of the scope of the work, pictures of the project, drawings used for the project, etc.

For example, a client looking at the vendor profile for an Architect that designed the specifically searched for “roof garden” will be presented with the material used by the Architect for the roof garden, as well as advertisements of different vendors that supply and install “roof gardens” in the selected area(s).

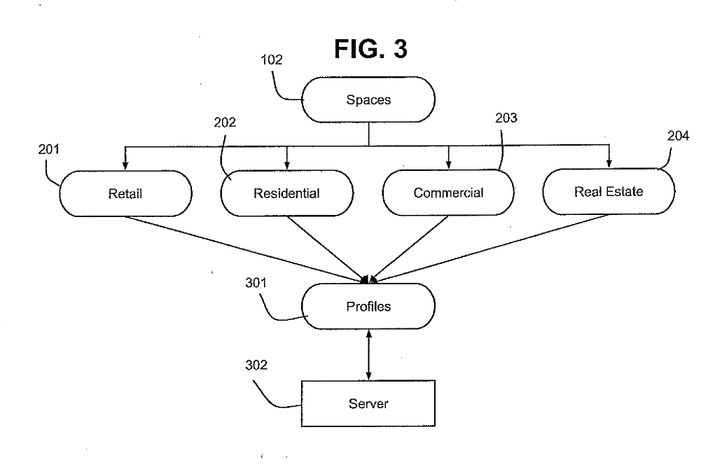

As shown in FIG. 3, each area is supported by the client's profile 301. The profiles may be stored in database software and managed by a server 302. The database software manages the information that the clients input into the profiles. The database software may further manage information input into the different areas (e.g., retail, residential, etc.). The database may link the information/contacts related to projects in the same location, under the same brand's name, by the same scope of work, etc.

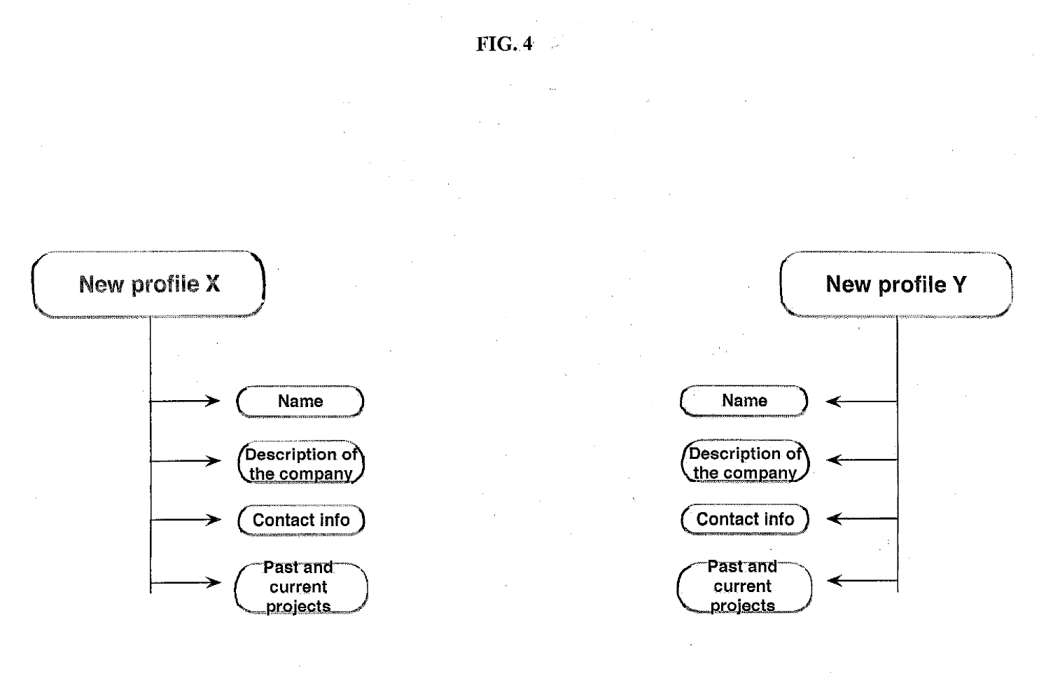

As shown in FIG. 4 for the clients to be present in the database, they create a profile. The profile may include the client's name (e.g., name of the company), description/resume of the client, the projects concluded in the past and the projects currently active. When two clients that are working on the same project (e.g., architect and millwork) update their profiles with the same project's name, the database collects and links this information, which is made available as a result for mining by any client of the system. That is, when each client creates a profile, information entered by the client may be automatically linked to other related information entered by other clients, as described above with reference to the example of an Architect working on a retail development on 5th Avenue in New York.

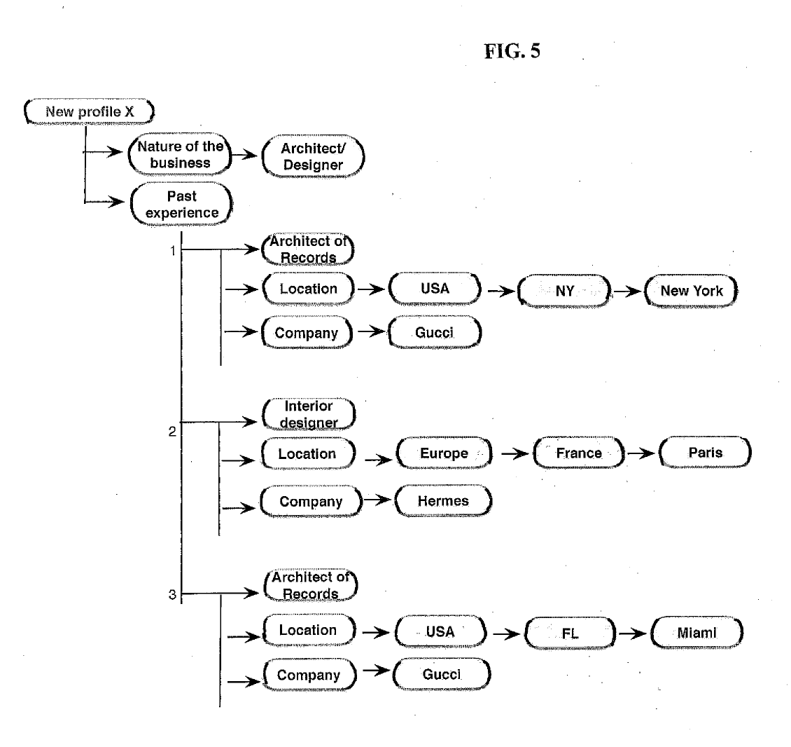

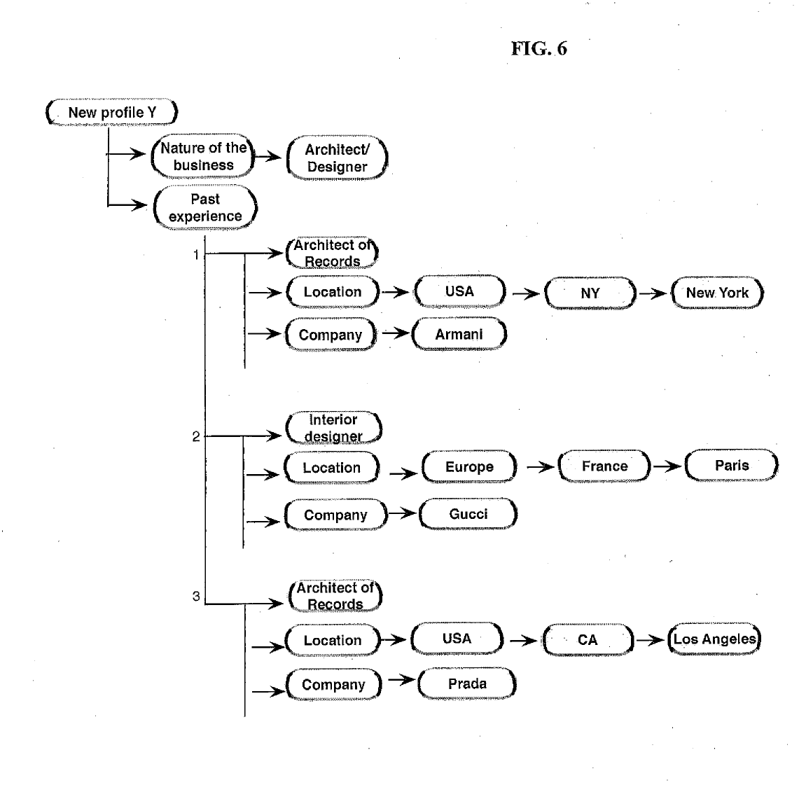

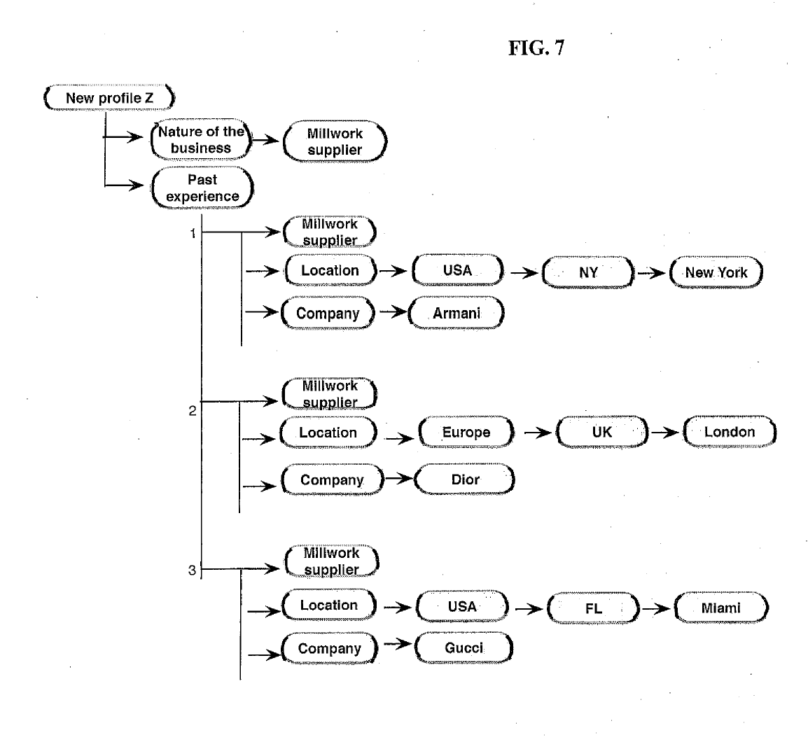

FIGS. 5, 6 and 7 show examples how a client may update their profiles with their past and current projects. For example, FIG. 5 shows the updating of a first profile (e.g., profile X), FIG. 6 shows the updating of a second profile (e.g., profile Y), and FIG. 7 shows the updating of a third profile (e.g., profile Z). Updating the profiles may include, for example, updating the locations of the project (e.g., USA, New York, Europe, Paris, etc.), the role of the client in each project (e.g., architect of record, designer, expeditor), and the company the client is working for (e.g., Gucci, Armani, Prada, etc.).

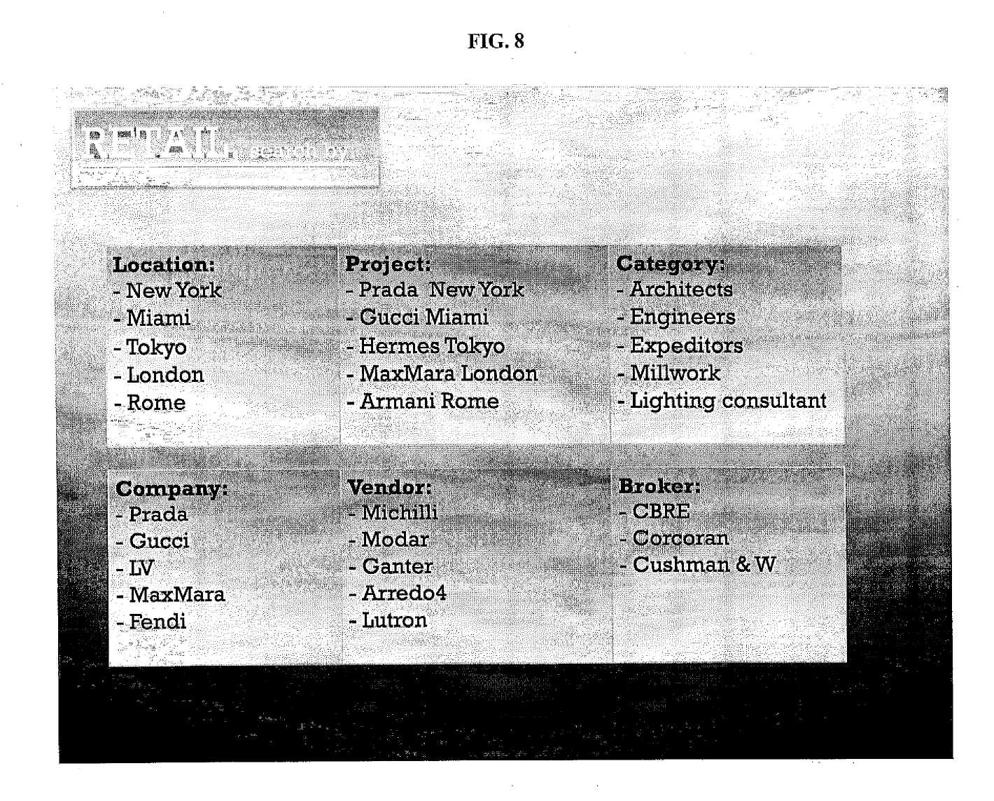

As shown in FIG. 8 the database will give the opportunity to search for information or contacts by different category (e.g., by locations, by specific projects, by categories, by companies, by vendors, by brokers, by brand's names, etc.) giving to each searcher different possibilities to find desired information.

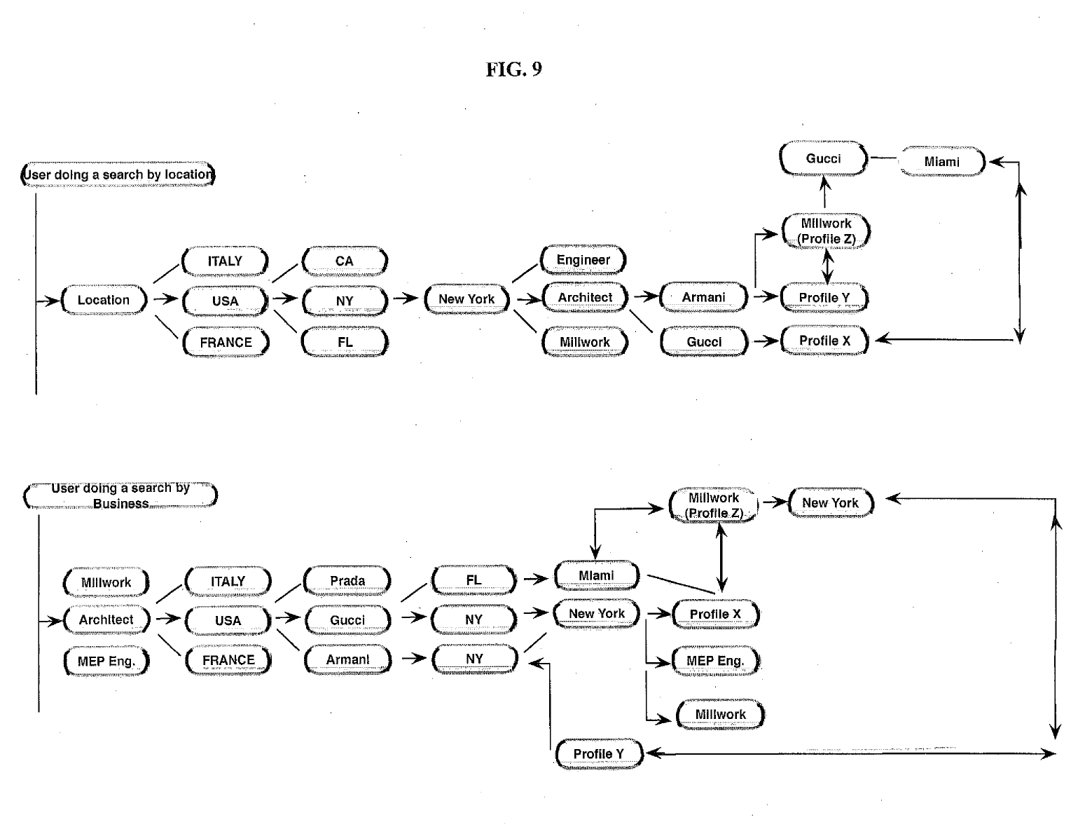

As shown in FIG. 9 the search can be made by location, by company, by business/scope of work, etc. When the clients update their profiles with new projects, the database will link each new information (e.g., location, brand's name, scope of work, etc.) and deliver the linked information in response to an appropriate query.

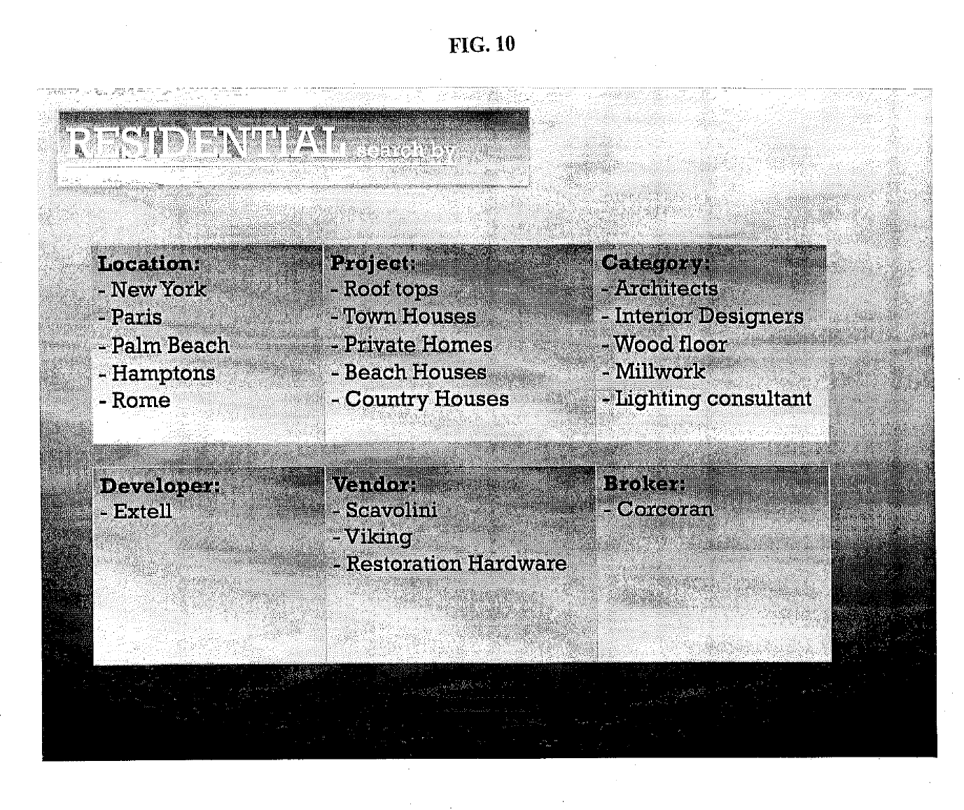

As shown in FIG. 10 the same concept applied for “retail” in FIG. 8 may be applied for “residential” where the database enables queries for information or contacts by different category (e.g., by locations, by specific projects, by categories, by developers, by vendors, by brokers, by brand's names, by scope of work, etc.) giving to each searcher different possibilities to find the information needed.

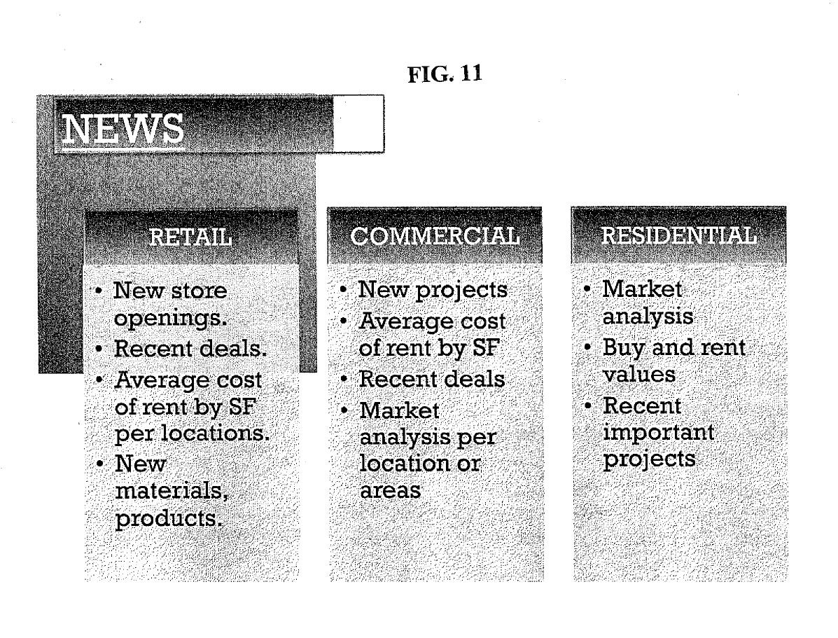

As shown in FIG. 11 the database will deliver information regarding the different areas. Clients will have the possibility to add information based on their expertise so that they may be shared and available for anyone (e.g., building permit process in the different locations).

For example, referring to the building permit process, a client using the project-based directory system may be presented with a list of information regarding the applications required for different projects in different cities. The project-based directory system may display contact information for each department in each city corresponding to the required applications.

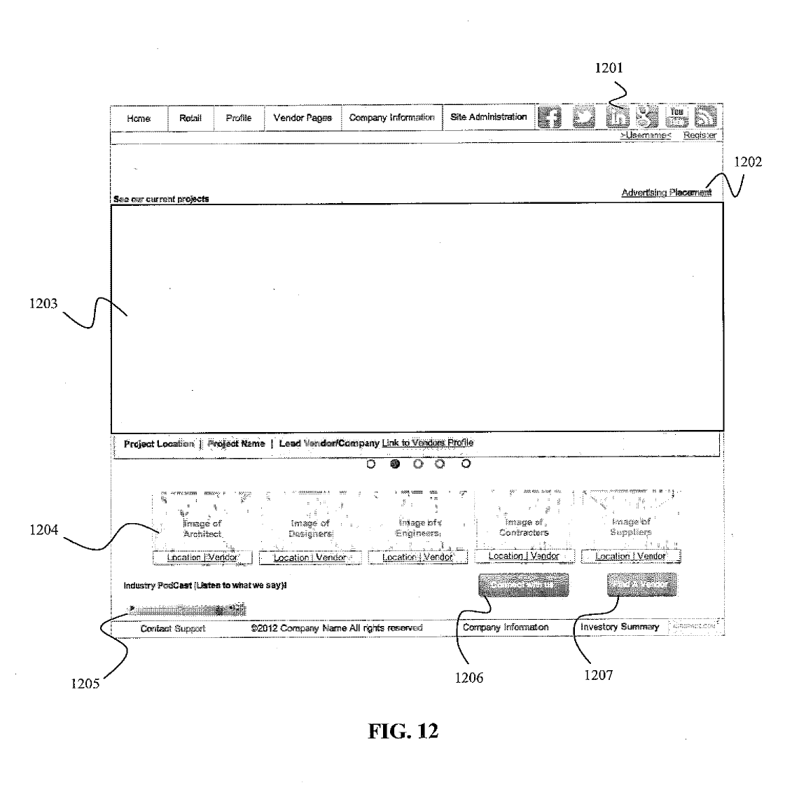

An example of different screens of a user interface providing access to the project-based directory according to embodiments of the present disclosure will be described herein with reference to FIGS. 12-15.

A user (e.g., a client) first logs in to the project-based directory system by entering credentials at a login screen. The credentials may include a username and password specifically created for the project-based directory. The project-based directory system may also utilize credentials from other commonly used services such as, for example, Facebook®, LinkedIn®, or Google+®.

Once logged in, the user is directed to a home page, where a variety of data may be displayed to the user. An exemplary home page is shown in FIG. 12. For example, the displayed data may include buttons 1201 linking to social media pages, including social media pages relating to the industry, an advertisement placement link 1202, which may display advertisements purchased by clients utilizing the project-based directory system, a main menu 1203 (e.g., a rotating banner) displaying project images including illustrative images showing a variety of work from various vendors registered in the project-based directory, and vendor category buttons 1204 allowing the user to view qualified vendors in the client's area (e.g., vendors may pay a premium to be featured in this section, and data illustrative of the vendors' recent work may be displayed in this section). As used herein, the term qualified vendors may refer to clients included in the project-based directory system other than the current user. The home page may also display an audio button(s) 1205 linking to audio content including, for example, audio statements or interviews from vendors, industry podcasts discussing certain companies/vendors and recent activity in the user's area, etc. The home page may also include an inquiry button 1206 that presents the user with a variety of options including, for example, creating a new project, finding a vendor, finding a space, making a general inquiry, purchasing an advertisement, etc, and a dedicated search button 1207 for searching for a vendor.

The dedicated search button 1207 may allow the user to perform an advanced search based on criteria including, for example, key words, tags, categories, store names (e.g., department stores, malls, shopping centers, etc.), address information, etc. When a vendor is found, the user may be presented with various options relating to the vendor such as, for example, sending the user's contact details to the vendor, requesting a call back from the vendor, requesting sales information (e.g., a sales brochure) from the vendor, requesting information about the vendor's clients, requesting an in-person meeting with the vendor, requesting client references from the vendor, requesting company information from the vendor, etc. The user may also save vendor information for later reference. For example, the user interface may include a “My Vendors” section that allows the user to save and review vendors of interest.

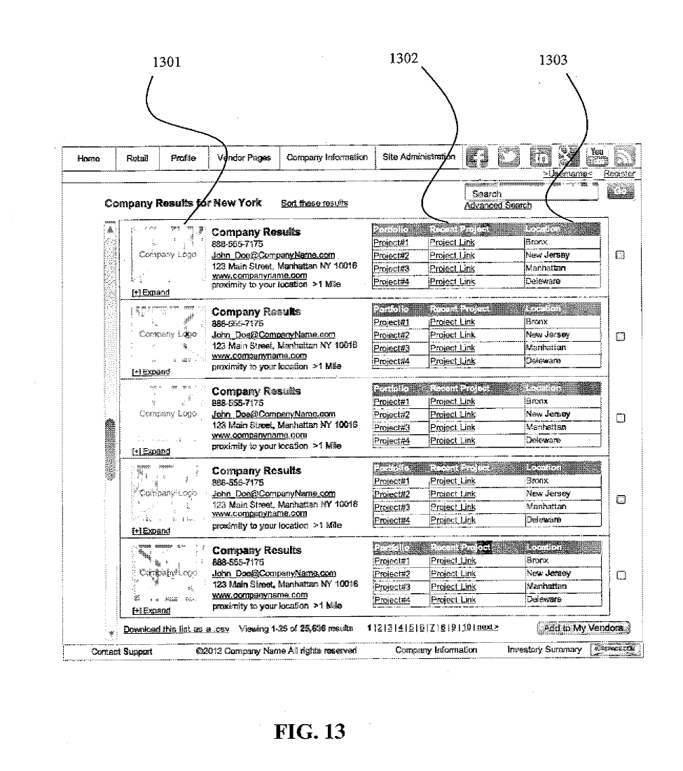

FIG. 13 displays a results page presented to the user when the user performs a location based search. As shown in FIG. 13, the results may include a listing of vendors in the area 1301, as well as links to the respective vendors' projects 1302 and locations 1303. The list may be exported by the user (e.g., as a .csv file), as well as sorted by the user based on a variety of criteria including, for example, street name, city name, shopping center (e.g., mall) name, store name, company name, year, etc.

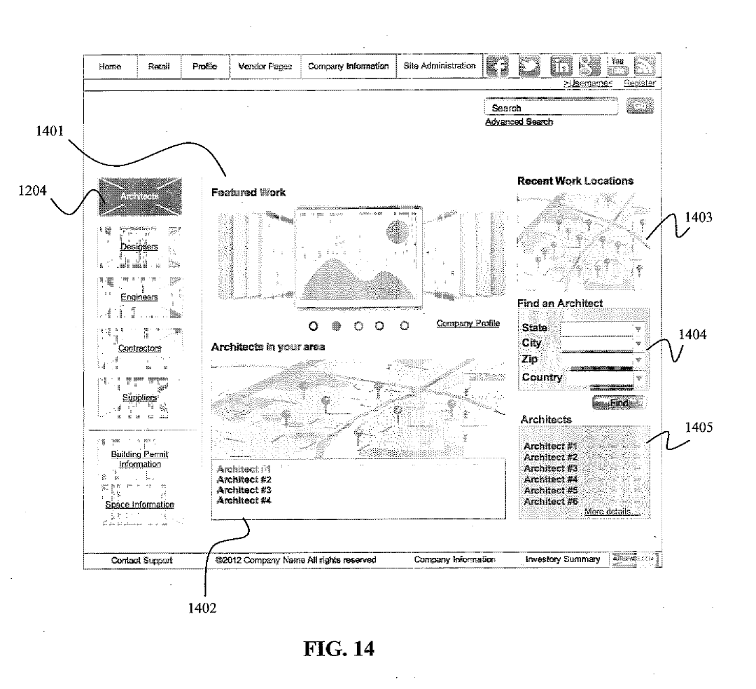

Selecting a vendor category button 1204 linking to a qualified vendor directs the user to a vendor display page corresponding to the type/category of vendor selected. An example of a vendor display page is shown in FIG. 14. Although FIG. 14 shows a vendor display page for an Architect, it is to be understood that vendor display pages for different types of vendors/categories (e.g., Designers, Engineers, Contractors, Suppliers, etc.) may appear and function similar to the vendor display page shown in FIG. 14.

The vendor display page includes vendor category buttons 1204 to view all types/categories of qualified vendors in the client's area (e.g., Architects, Designers, Engineers, Contractors, Suppliers, etc.). A vendor profile area 1401 displays featured work of a selected vendor. The user may scroll though various vendors in the vendor profile area 1401. The vendor profile area 1401 may include any number of vendors (e.g., hundreds or thousands of vendors). The vendor display page may further include a map area 1402 that shows the location of qualified vendors on a map. The vendor profile area 1401 and the map area 1402 are linked to each other. For example, selecting an image in the vendor profile area 1401 will focus on the corresponding location (e.g., a pin) in the map area 1402, and selecting a location (e.g., a pin) in the map area 1402 will display the corresponding image for that vendor in the profile area 1401. The vendor display page may further include a recent work locations area 1403 displaying work recently performed by the selected vendor (e.g., past projects), a search area 1404 to search for a vendor based on different location criteria, and a ratings area 1405 displaying ratings of the vendor (e.g., ratings created by other clients utilizing the project-based directory system).

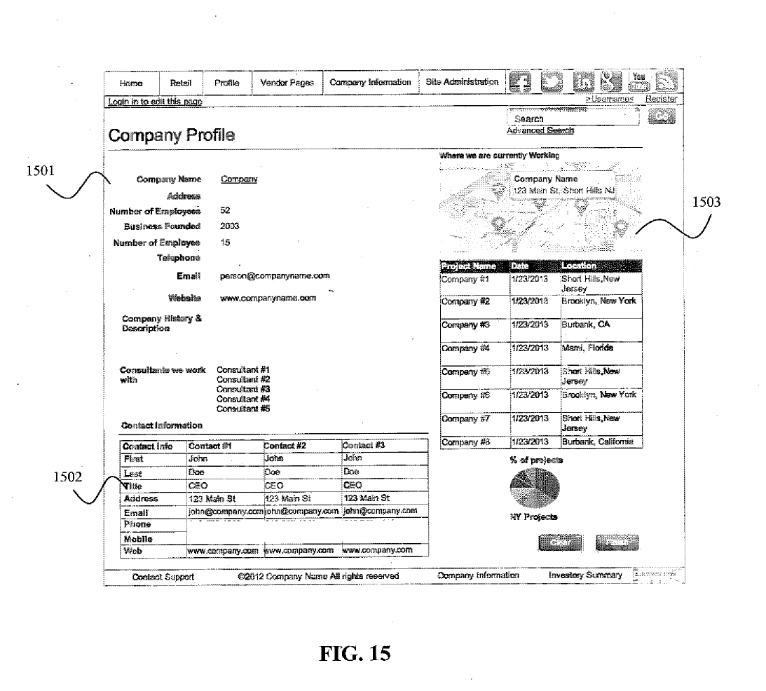

Once a vendor is selected, the user is directed to the vendor's profile page. An example of a vendor profile page is shown in FIG. 15. The vendor profile page includes a vendor information section 1501, a contact information section 1502, and a project information section 1503.

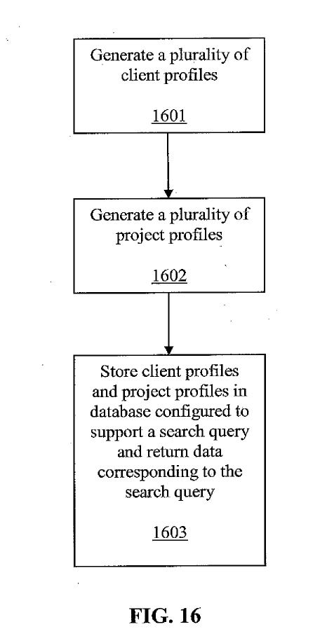

FIG. 16 is a flowchart showing a method of managing a project-based database system, according to embodiments of the present disclosure. A plurality of client profiles and a plurality of project profiles are generated at blocks 1601 and 1602. At block 1603, the plurality of client profiles and the plurality of project profiles are stored in a database. As described above, the database is configured to support a search query and return data corresponding to the search query. Each project profile is associated with at least one client profile, and each of the client profiles is associated with at least one project profile.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

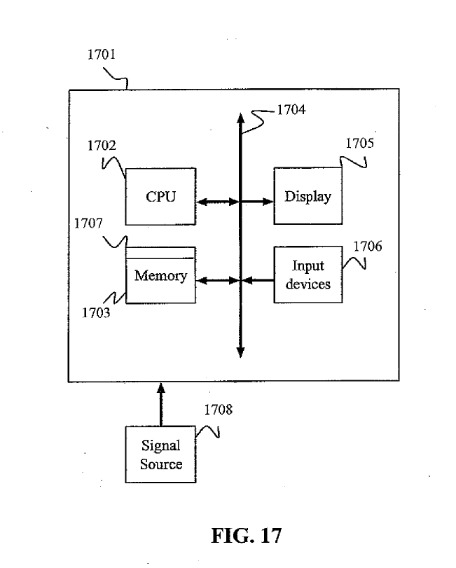

Referring to FIG. 17, according to an embodiment of the present invention, a computer system 1701 supporting a project-based database, inter alia, a central processing unit (CPU) 1702, a memory 1703 and an input/output (I/O) interface 1704. The computer system 1701 is generally coupled through the I/O interface 1704 to a display 1705 and various input devices 1706 such as a mouse and keyboard. The support circuits can include circuits such as cache, power supplies, clock circuits, and a communications bus. The memory 1703 can include random access memory (RAM), read only memory (ROM), disk drive, tape drive, or a combination thereof. The present invention can be implemented as a routine 1707 that is stored in memory 1703 and executed by the CPU 1702 to process the signal from the signal source 1708. As such, the computer system 1701 is a general-purpose computer system that becomes a specific-purpose computer system when executing the routine 1707 of the present invention.

The computer platform 1701 also includes an operating system and micro instruction code. The various processes and functions described herein may either be part of the micro instruction code, or part of the application program (or a combination thereof), which is executed via the operating system. In addition, various other peripheral devices may be connected to the computer platform such as an additional data storage device and a printing device.

It is to be further understood that, because some of the constituent system components and methods depicted in the accompanying figures may be implemented in software, the actual connections between the system components (or the processes) may differ depending upon the manner in which the present invention is programmed. Given the teachings of the present invention provided herein, one of ordinary skill in the related art will be able to contemplate these and similar implementations or configurations of the present invention.

Having described embodiments for a project-based database, it is noted that modifications and variations can be made by persons skilled in the art in light of the above teachings. It is therefore to be understood that changes may be made in the particular embodiments of the invention disclosed which are within the scope and spirit of the disclosure.

What is claimed is:

1. A project-based database system, comprising:
a plurality of client profiles; and
a plurality of project profiles,
wherein each project profile is associated with at least one client profile and each of the client profiles is associated with at least one project profile, and
wherein the plurality of client profiles and the plurality of project profiles are stored in a database configured to support a search query and return data corresponding to the search query.

2. The project-based database system of claim 1, wherein each project profile is further associated with a plurality of parameters including a location, an address, and a project description.

3. The project-based database system of claim 1, further comprising:
a spaces database comprising a retail area, a residential area, a commercial area, and a real estate area, wherein the plurality of client profiles is stored in the spaces database and the plurality of client profiles is divided among the retail area, the residential area, the commercial area, and the real estate area based on a client indicator;
an information database, wherein the plurality of project profiles is stored in the information database; and
an advertisement and communication facilities database comprising advertisement data corresponding to at least one client profile.

4. The project-based database system of claim 2, wherein each client profile comprises data corresponding to a vendor providing products or services, and each project profile comprises data corresponding to a construction project.

5. The project-based database of claim 4, wherein the search query is based on a vendor category.

6. The project-based database of claim 5, wherein the vendor category comprises an architect, a designer, an engineer, a contractor, or a supplier.

7. The project-based database system of claim 1, wherein the search query is based on a key word representing a product or a service designated in at least one of the plurality of client profiles.

8. A method of managing a project-based database system, comprising:
generating a plurality of client profiles;
generating a plurality of project profiles; and
storing the plurality of client profiles and the plurality of project profiles in a database configured to support a search query and return data corresponding to the search query,
wherein each project profile is associated with at least one client profile and each of the client profiles is associated with at least one project profile.

9. The method of claim 8, wherein each project profile is further associated with a plurality of parameters including a location, an address, and a project description.

10. The method of claim 8, further comprising:
storing the plurality of client profiles in a spaces database comprising a retail area, a residential area, a commercial area, and a real estate area, wherein the plurality of client profiles is divided among the retail area, the residential area, the commercial area, and the real estate area based on a client indicator; and
storing the plurality of project profiles in an information database.

11. The method of claim 9, wherein each client profile comprises data corresponding to a vendor providing products or services, and each project profile comprises data corresponding to a construction project.

12. The method of claim 8, further comprising receiving the search query, wherein the search query is based on a location, a specific project, a vendor name, or a vendor category.

13. The method of claim 12, wherein the vendor category comprises an architect, a designer, an engineer, a contractor, or a supplier.

14. The method of claim 8, further comprising receiving the search query, wherein the search query is based on a key word representing a product or service designated in at least one of the plurality of client profiles.

15. The method of claim 14, further comprising generating an advertisement corresponding to at least one client profile based on the key word.

16. A computer readable storage medium embodying instructions executed by a processor to perform a method of managing a project-based database system, comprising:
generating a plurality of client profiles;
generating a plurality of project profiles; and
storing the plurality of client profiles and the plurality of project profiles in a database configured to support a search query and return data corresponding to the search query,
wherein each project profile is associated with at least one client profile and each of the client profiles is associated with at least one project profile.

17. The computer readable storage medium of claim 16, wherein each project profile is further associated with a plurality of parameters including a location, an address, and a project description.

18. The computer readable storage medium of claim 17, wherein each client profile comprises data corresponding to a vendor providing products or services, and each project profile comprises data corresponding to a construction project.

19. The computer readable storage medium of claim 16, wherein the search query is based on a location, a specific project, a vendor name, or a vendor category, and the vendor category comprises an architect, a designer, an engineer, a contractor, or a supplier.

20. The computer readable storage medium of claim 16, wherein the search query is based on a key word representing a product or service designated in at least one of the plurality of client profiles.
